(19) United States
(12) Patent Application Publication
(10) Pub. No.: US 2022/0415220 A1
(43) Pub. Date: Dec. 29, 2022

(54) Wireless Status Sign System

(71) Applicant: BusyBox LLC, Whitinsville, MA (US)

(72) Inventor: Steve Skillings, Whitinsville, MA (US)

(21) Appl. No.: 17/828,235

(22) Filed: May 31, 2022

Related U.S. Application Data
(60) Provisional application No. 63/214,455, filed on Jun. 24, 2021.

(51) Int. Cl. G09F 13/04

(52) U.S. Cl. CPC G09F 13/0445; G09F 13/0413

(57) ABSTRACT

A status sign has a stencil, a cover, a mounting plate, and a main assembly therebetween. The main assembly comprises a battery and a printed-circuit board having circuitry for controlling light emitted from the main assembly. The stencil has openings that provide information indicative of status. The stencil is disposed to be illuminated when slid between the main assembly such that light from the main assembly passes through the openings and renders the information visible.

### CROSS REFERENCE TO RELATED APPLICATIONS

This application is a non-provisional application, which claims the benefit of the filing date of provisional application No. 63/214,455, filed Jun. 24, 2021, the contents of which are incorporated herein by reference in their entirety.

### BACKGROUND

Most illuminated signs are plugged into a wall and have a manual switch mechanism for their control whether it is a pull cord or a rocking electromechanical switch. Most also have one color of light and a single brightness setting. The origins appear to go back to the “ON AIR” signs of the radio studios of the early 1900s and may be used in recording studios today.

Sometimes it is desirable to communicate the status of a room's occupant with someone who is outside the room using a signal that can be seen without entering the room. Often a simple door sign with a sliding cover or a circular cutout to hang it from the doorknob will be used. When using these rudimentary systems, it is often easy to forget to change the status of the room. After all, doing so would require the person to get up, go to the door, and switch a sign from, for example, “Do Not Disturb” to “Welcome.”

It is desirable to alert those outside the room to the state of a person within the room. Advance notice prevents the embarrassment of walking in on a video call or audio call. Such notice also avoids disturbing a person's focus, thus impairing that person's productivity.

It is a challenge to install a wired, single color, hard-switched sign in a wall. Doing so often requires an electrician and to wire a switch, to make a mounting hole, and to run a wire inside the wall. It is an aesthetically unpleasant and possibly dangerous solution to install a status light on a door with a wire placed on the door itself. And actually mounting it to the door requires special skills and equipment.

### SUMMARY

In one aspect, the invention features an apparatus that includes a status sign having a stencil, a cover, a mounting plate, and a main assembly therebetween. The main assembly comprises a battery and a printed-circuit board having circuitry for controlling light emitted from the main assembly. The stencil has openings that provide information indicative of status. The stencil is disposed to be illuminated when slid between the main assembly such that light from the main assembly passes through the openings and renders the information visible.

Some embodiments include a sensor mounted on the printed-circuit board. Examples of sensors include photometers, thermometers, mechanical switches, capacitive sensor, distance sensors, force sensors, hygrometers, accelerometers, gyroscopes, global positioning systems, and thermal imaging devices, and the like, to assess the status of an environment, or the motion/location of the status sign, to help all who might enter, or exit, the environment, such as a room or hall.

Other embodiments include a table stand having a base and a support, wherein the support holds the status sign and transfers the status sign's weight to the base. Among these are embodiments that have a mounting screw to connect the support to the status sign.

In still other embodiments, the main assembly and the mounting plate comprise alignment features that guide the main assembly when the main assembly is being mounted to the mounting plate.

Also, among the embodiments are those in which the circuitry is configured to control color of the illumination.

Still other embodiments are those in which the circuitry comprises a network interface to permit remote control of the status sign.

To promote ease of mounting, some embodiments include a first portion of a hook-and-loop fastener on the mounting plate to permit the mounting plate to be mounted on a corresponding second portion of the hook-and-loop fastener.

Embodiments further include those in which the sign can be operated remotely operated manually, those in which it has a battery, those in which it has changeable messages, and those in which it can communicate over a network with other devices, including other signs.

Still other embodiments include those that connect to remote controls like smart phones, RF remotes, Wi-Fi systems, computers, IR remotes, and more, to allow for control when the status sign is not within arm's length.

Other embodiments are those that are durable enough to withstand shocks such as those that arise when a door is slammed. A suitable level of shock resistance is on the order of 5 g. This is useful since doors can sometimes swing shut as a result of a gust of wind or, in some rare cases, as a means of communicating elevated emotion.

Other embodiments are those status signs that are mounted to multiple brackets to allow for different uses, such as being mounted on a table stand, mounted on a door, mounted on a wall, mounted on glass, and mounted on a tripod.

Some embodiments emit a sound. Such embodiments include sound-emitting transducers, such as a loudspeaker or a piezoelectric disk.

Still other embodiments include interchangeable or swappable covers to allow for the status sign to match the owner's aesthetic preferences.

Embodiments also include those in which the status sign communicates with a distributed computer system, such as a “cloud” computer, or with a mobile device. In such embodiments, the status sign receives commands remotely, performs an action, and reports back to the commanding device when the action is complete.

Other embodiments create a mesh network of devices in which each device can carry a command from one to the next in a “serial” or “broadcast” method. This is particularly useful for implementing a safety alert system that would warn of such unpleasant events as tornados, fire, and tsunamis. Such mesh networks communicate with local and federal alert systems or with internal building systems to receive messages concerning fire alarms, shelter-in-place alarms, shift changes, or any other messages that can be sent to the status sign for communication via the status sign.

Further embodiments include message holders and cable holders that enhance the value and functionality of the status sign.

Embodiments includes status signs that can be controlled via a variety of methods.

Among these are embodiments in which a user create status and alert messages that illuminate and can be controlled manually by the user, electronically by a different user or electronically by a computer system using radio or cabled communication. Such embodiments include plural messages and lighting options.

Embodiments include those in which the user charges the battery or connect the device to a continuous power source such as a cable, and, if desired, connect the device to a smart phone and/or computer system. The status sign is then placed on a door, wall, tabletop, desk, window, or any location that works best for the user's application.

Once placed, the status sign signals people inside or outside the room to provide them with information concerning the status of the room's occupant. Examples of status messages include simple messages, such as “Do Not Disturb” or messages that rely on color, different text, and operational modes, such as blinking and stead illumination. By way of example, a person working from home may use green illumination with the message “busy” to indicate they are doing work, but if someone wants to enter they may because they are open to visitors. Yellow illumination with the message “busy” could mean, “I am busy and not to be disturbed unless it is something important.” Red illumination with the message “busy” could mean, “I am busy with something very important, do not disturb unless it's something incredibly urgent.” The use of color combined with text thus provides the text to take on different shades of meaning.

Similarly, the messages themselves can convey meaning. For example, the status sign can easily change from “Busy” to “On Air” to “Studying.” An emoji of a circle with a line through it provides a way to discourage entry in a more fun and comical way than block letter text, for example.

Likewise, because the status sign is controllable, the user might use different light modes to indicate different statuses. For example a flashing sign could mean, “Be alert, this message is important.” In contrast, a color fading rainbow light could indicate that a room is open for use and is available. Similarly, a slow pulsing light could indicate that the room is busy but does so in a way that saves on battery power. This power savings arises because slow pulsations use less current than rapid blinking, and less than an always on state of operation.

The objective of handling a strong g-force incident is handled in the design of the mechanical structure and component selection. With the accelerometer, g-force sensor and gyroscope sensor, the device may allow the user to run the device in “landscape” and “portrait” mode for different status messages. The user may also use the sensing features to enhance the utility of the device, for when a person enters or leaves the room, such as using the proximity sensors to turn the status sign on or off, or to turn on or off the HVAC system. Similarly, the objective of having the device being able to measure and report room data, such as temperature, humidity, light and more, may communicate to the building's central control system for lights, HVAC, etc., singularly or as a group, to improve the comfort level in the room, save electricity, indicate occupancy, and other useful data. The swappable covers allow the device to easily hide and access the charge port for safety and aesthetic reasons and allows the user to choose from a plurality of cover designs that may be more appropriate for their application, from home offices to industrial to educational institutions.

Some embodiments provide different colors of light to express different levels of accessibility. For example, in some embodiments, the status sign switches between three colors, such as green, yellow, and red. A green light would indicate that the room's occupant is available. A yellow light would indicate that the room's occupant is busy but could nevertheless endure an interruption. A red light would indicate that the room's occupant is engaged in a task that would be seriously compromised in the event of an interruption.

A difficulty that can arise in a status sign is that the switch is outside the room and therefore the occupant within the room cannot actually see the state of the status sign. The invention overcomes this disadvantage by providing the occupant with information on the status sign and control over its state from within the room that the status sign protects.

Yet another difficulty that can arise in a status sign that is hardwired, particularly if the sign is on a door, is that slamming the door may cause the sign to fall off. This can expose bare wires carrying ac current, thus creating a danger to those nearby who may inadvertently touch them.

The status sign described and claimed herein avoids this difficulty by avoiding the need to be connected to an ac power source. Instead, the status sign relies on a rechargeable battery.

Yet another advantage of the status sign is that the message is simple to replace.

The described device may come in a plurality of shapes, materials, and sizes to accommodate a plurality of applications and aesthetics.

The features of the present invention which are believed to be novel are set forth in this application and in particular, in the appended claims. Other objectives and many of the features of this invention will be more readily appreciated and understood by reference to the following detailed descriptions and diagrams.

Other features and advantages of the invention are apparent from the following description, and from the claims.

### DESCRIPTION OF DRAWINGS

FIG. 1 is a view of the status sign.

FIG. 2 is an exploded view of the status sign showing four main components thereof.

FIG. 3 is a back view of the status sign showing three of the four main components thereof.

FIG. 4 shows a view of the printed circuit board (PCB) and battery by removing the plastic backplate.

FIG. 5 shows a section view of the status sign.

FIG. 6 shows a view of the status sign using the mounting system and a table stand.

FIG. 7 shows an exploded view of the mounting system used for a tripod.

### DESCRIPTION

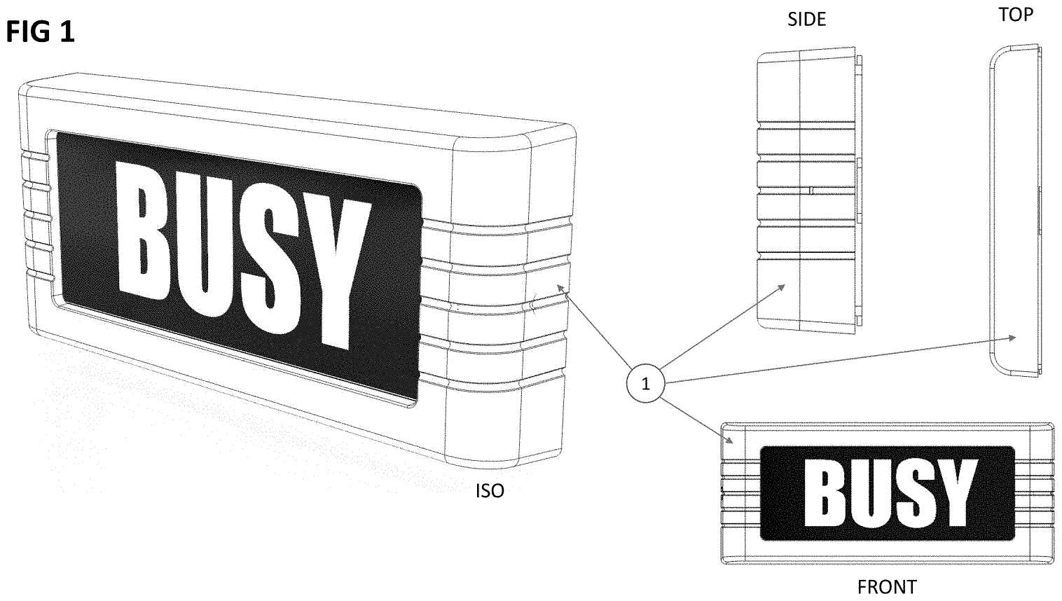

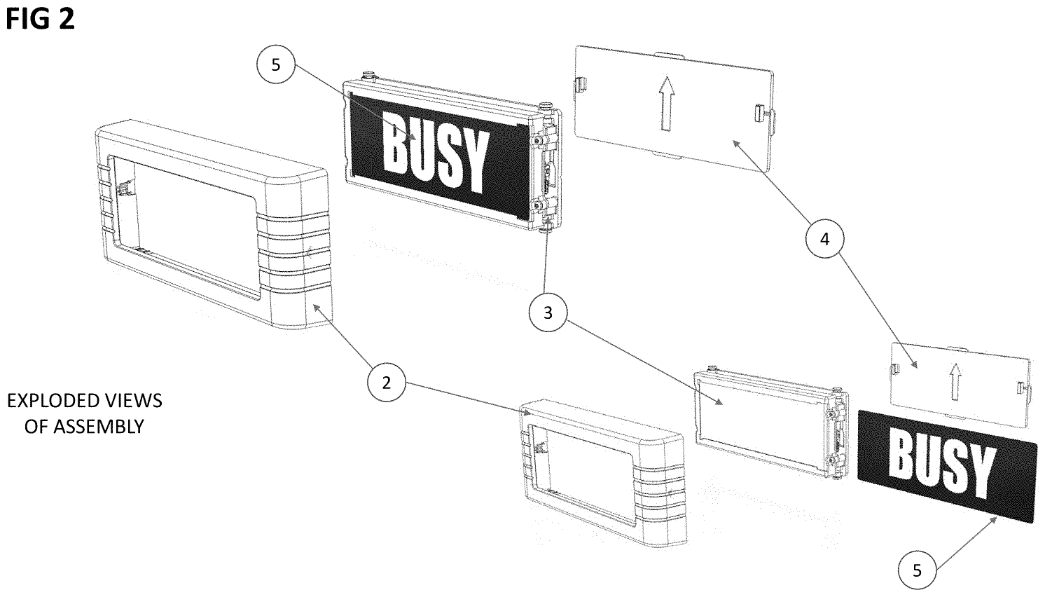

FIG. 1 shows several views of a status sign 1 in a typical operational mode in which a cover 2 and a mounting plate 4, both shown in FIG. 2, hold a main assembly 3 therebetween. A slide-in stencil 5, also shown in FIG. 2, is in its normal operating position.

The stencil 5 includes a symbol that communicates a status. Typically, the status is that of a person inside a room that is associated with the status sing 1. In the illustrated embodiment, the symbol takes the form of alphanumeric characters.

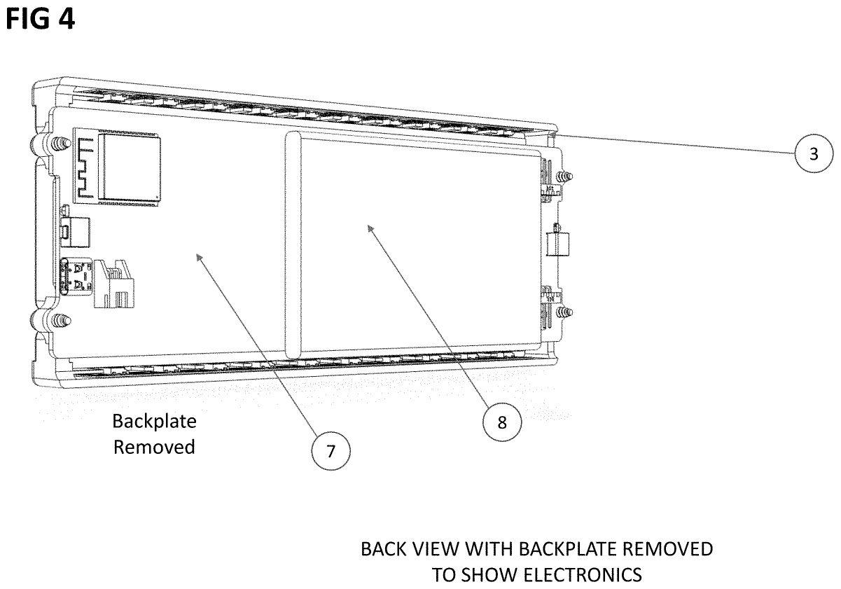

FIG. 2 shows a view of the device disassembled in a way that makes it easy to charge a battery 8, which is shown in FIG. 4. In FIG. 2, the cover 2 has been removed from the main assembly 3 and the mounting plate 4. The main assembly 4 and the mounting plate 4 both remain on the wall. The lower right portion of FIG. 2 shows the slide-in stencil 5 after having been removed from the main assembly 3.

In some embodiments, the mounting plate 4 is attached to a wall or door with a hook-and-loop fastener, a hook-and-pile fastener, or some other attachment method that permits easy detachment. The main assembly 3 is then pushed onto the mounting plate 4 and slid down on hooks that are molded into the mounting plate 4. This easy-to-use mounting system allows the main assembly 8 to be quickly removed for charging the battery 8.

The ability to remove the cover 2, as shown in FIG. 2 is useful for those embodiments in which the cover 2 blocks access to the charging port for the battery 8. Blocking access to the charging port. Blocking such access is useful for safety, for example for preventing foreign bodies from entering, or for ornamental or aesthetic reasons, such as to cover an unsightly opening.

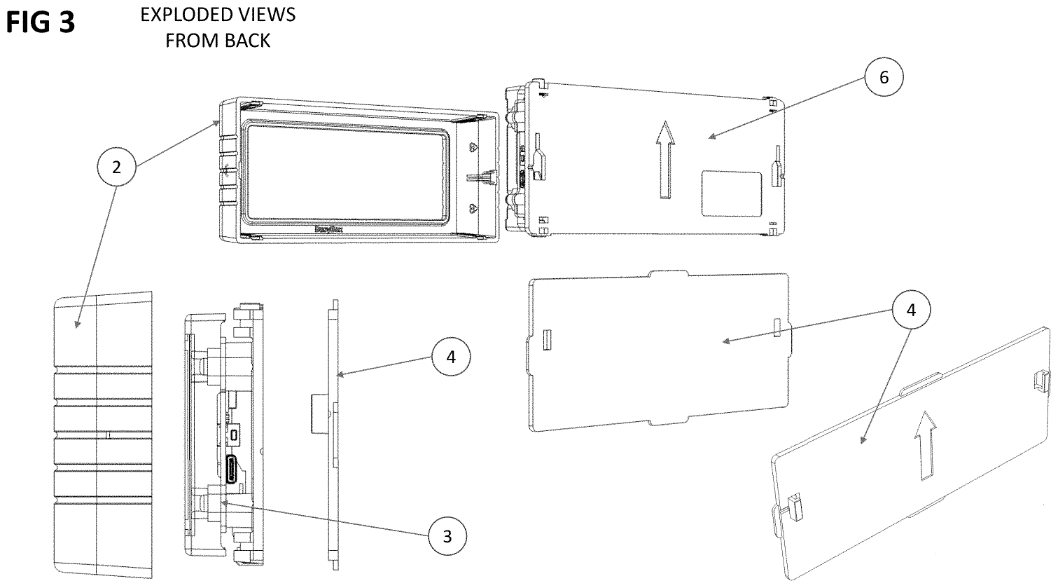

FIG. 3 shows a view of the status sign 1 from the back after having been disassembled. FIG. 3 also shows both sides of the mounting plate 4 and shows a rear plate 6 of the main assembly 3. The rear plate 6 permits the mounting plate 4 to be easily removed from a wall or door. In some embodiments, the mounting plate 4 and rear plate 6 have alignment features, such as arrows and notches, to make mounting the status sign 1 easier. In some embodiments, the status sign 1 is sufficiently robust to withstand high g-forces should the door be slammed by, for example, a gust of wind.

FIG. 4 shows a detailed view of a printed circuit board (PCB) 7 and the battery 8. The PCB 7 can house a plurality of sensors such as hygrometers, gyroscopes, thermometers, proximity sensors, GPS, thermal imaging, g-sensors, capacitance sensors, accelerometers, and other sensors. These sensors permit the status sign 1 to monitor the space around it for temperature, motion, light level, motion of the unit, and orientation of the unit. Information from these sensor can then be communicated to a central processing unit (CPU) on the PCB 7, which then has the option of using this information to carry out various tasks. Such tasks include operating the device locally. Alternatively, the information acquired from the sensors can be transmitted via cable or wirelessly to another computer system or mobile phone to operate the device locally or remotely. The PCB 7 in some embodiments may have mechanical switches to control local operations like on/off, light color change, and the like, or to send data via the CPU to a central computer system or phone.

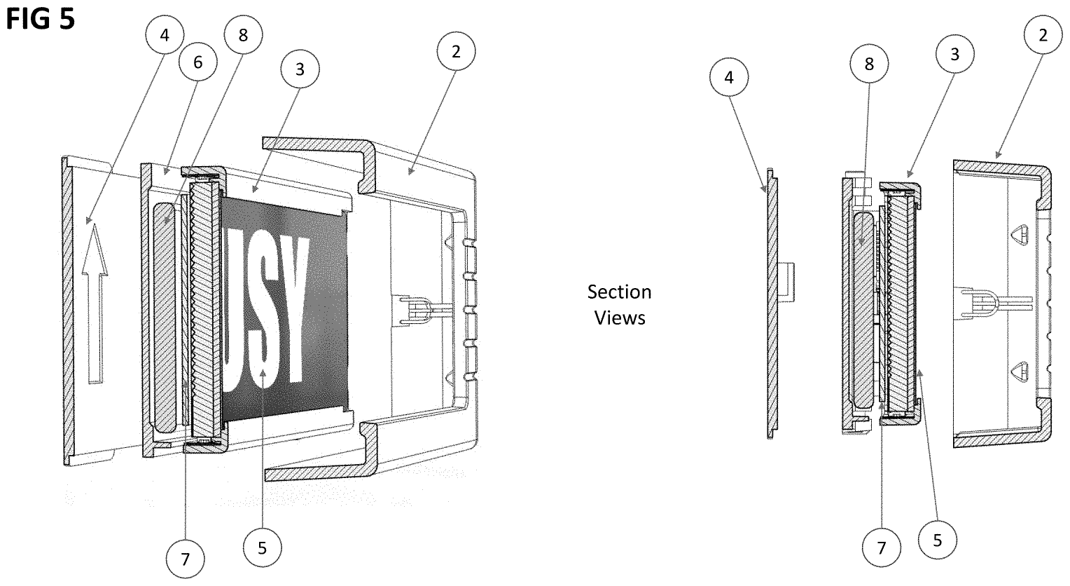

FIG. 5 shows a side view of the status sign 1 indicating the spatial relationships of the foregoing components.

A variety of mounting systems can be used to mount the status sign 1 at a location other than on a wall or door.

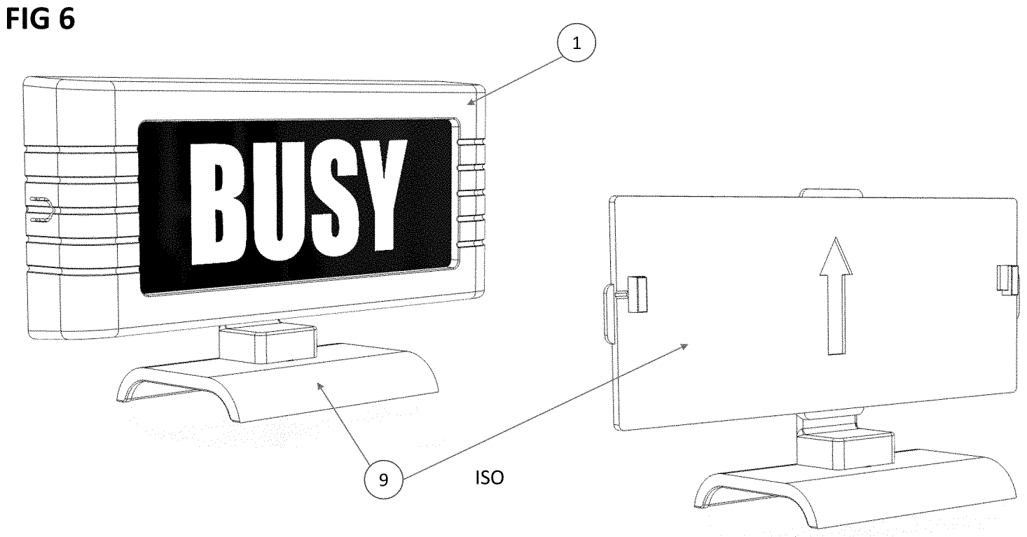

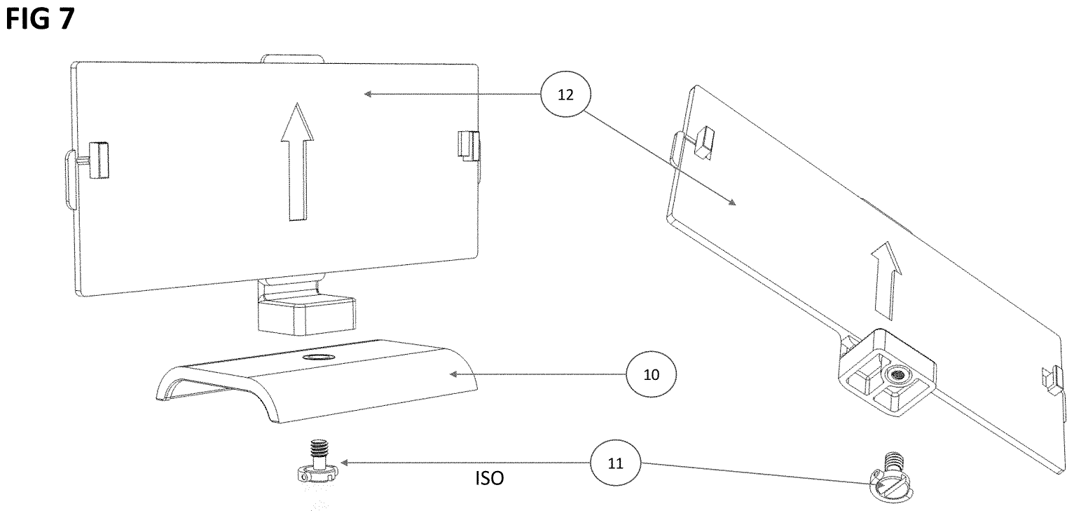

Some embodiments feature a table stand 9 that engages the status sign 1, as shown in FIG. 6. The table stand 9 provides an aesthetically pleasing option for positioning the status sign 1 on a table or shelving unit. As shown in FIG. 7, some embodiments of the table stand 9 have a mounting screw thread to accept a mounting screw 11 to use with a tripod or other system. As a result, it is possible to mount the status sign 1 in any one of a variety locations.

It is apparent that the structural features of the invention can be obtained by a variety of materials and construction methods to those knowledgeable in the art.

It is to be understood that the foregoing description is intended to illustrate and not to limit the scope of the invention, which is defined by the scope of the appended claims. Other embodiments are within the scope of the following claims.

What is claimed is:

1. An apparatus comprising a status-sign (1), said status sign having
a stencil (5),
a cover (2),
a mounting plate (4), and
a main assembly (3) therebetween,
wherein said main assembly comprises
a battery (8) and
a printed-circuit board (7) having circuitry for controlling light emitted from said main assembly,
wherein said stencil has openings that provide information indicative of status, said stencil being disposed to be illuminated when said stencil is slid between said main assembly such that light from said main assembly passes through said openings and renders said information visible.

2. The apparatus of claim 1, further comprising a sensor mounted on said printed-circuit board.

3. The apparatus of claim 1, further comprising a table stand having a base and a support, wherein said support holds said status sign and transfers said status sign's weight to said base.

4. The apparatus of claim 4, further comprising a mounting screw to connect said support to said status sign.

5. The apparatus of claim 1, wherein said main assembly and said mounting plate comprise alignment features that guide said main assembly when said main assembly is being mounted to said mounting plate.

6. The apparatus of claim 1, wherein said circuitry is configured to control color of said illumination.

7. The apparatus of claim 1, wherein said circuitry comprises a network interface to permit remote control of said status sign.

8. The apparatus of claim 1, further comprising a first portion of a hook-and-loop fastener on said mounting plate to permit said mounting plate to be mounted on a corresponding second portion of said hook-and-loop fastener.
